(19) United States
(12) Patent Application Publication
(10) Pub. No.: US 2002/0010825 A1
(43) Pub. Date: Jan. 24, 2002

(54) Memory resource arbitrator for multiple gate arrays

(76) Inventor: Alex Wilson, Oxford (GB)

Correspondence Address: KEVIN J. ZILKA, P.O. BOX 721120, SAN JOSE, CA, 95172-1120, US

(21) Appl. No.: 09/841,701

(22) Filed: Apr. 23, 2001

Related U.S. Application Data
(63) Continuation-in-part of application No. 09/687,481, filed on Oct. 12, 2000.
(63) Continuation-in-part of application No. 09/687,012, filed on Oct. 12, 2000.
(60) Provisional application No. 60/219,808, filed on Jul. 20, 2000.

(51) Int. Cl. G06F 12/00; G06F 13/14; G06F 13/38

(52) U.S. Cl. 710/240

(57) ABSTRACT

A system, method and computer program product for arbitrating access to a shared memory resource by a plurality of gate arrays. During use, operations are executed on a plurality of gate arrays. Further, the gate arrays are allowed access to at least one shared memory resource during the execution of the operations thereon. Such access to the at least one shared memory resource is arbritrated to prevent conflict between the gate arrays.

### RELATED APPLICATION(S)

The present application is a continuation-in-part of a parent application filed Oct. 12, 2000 under Ser. No. 09/687,481, and is further a continuation-in-part of a parent application filed Oct. 12, 2000 under Ser. No. 09/687,012 which in turn claims priority of a provisional application filed Jul. 20, 2000 under Ser. No. 60/219,808.

### FIELD OF THE INVENTION

The present invention relates to resource arbitration and more particularly to allowing multiple hardware modules, i.e. gate arrays, to access shared resources.

### BACKGROUND OF THE INVENTION

Multiprocessing techniques have become widely used in computing systems. Essentially, multiprocessing systems employ a plurality of processing devices operated substantially independent from one another to thereby enable the computing system to simultaneously accomplish a variety of different tasks.

Rather than provide each of the processers with a separate mass storage memory, multiprocessing systems generally employ a single mass storage device, such as core memory. Each of the processors in the multiprocessing system must therefore communicate with the single mass storage device when a memory instruction is to be performed by the associated processing system. Since a single memory may be accessed by a single requestor at any one time, a technique must be devised for choosing between two or more processors which desire to access the central memory at the same time.

Prior art techniques for selecting the processor have generally involved the use of discrete combinatorial and sequential logic elements and have therefore been highly complex and cumbersome in use. Further, such prior art techniques are relatively inflexable in operation, thus limiting the ability of such system to accommodate for particular contingency. For example, in many systems, the routine priority scheme may be upset by special memory requests, such as a multi-cycle request where the requesting processor requires a memory access involving more than a single memory cycle. Other special priority requests include “super priority” requests such as memory refresh cycles which must be performed to the exclusion of all other memory accesses. The prior art techniques employing discrete components cannot easily accommodate such non-routine memory requests without involving highly complex circuitry.

Additionally, it is important that priority assignments not be static in nature. That is, priorities should be rotated on a predetermined basis such that all requesters will be given an equal opportunity to access memory, assuming that such is desired. For example, if requestor 1 has priority over requestor 2 at all times, requestor 2 will clearly be given less opportunity with access memory compared to requestor 1. The priorities must therefore be rotated over time to effect an equal distribution among the requesters. This requires complex sequential logic when implemented in discrete form leading to a complex and cumbersome system.

Finally, in systems having a relatively large number of requestor lines, it is highly probable that one or more of the requestor lines will not be used by any of the requesters. It has been found that under certain conditions a requestor line which is not connected to a requestor may temporarily be mistaken as a requesting processor. Acknowledgement of such “spurious” requests results in wasted memory time and overhead.

It is well known that software-controlled machines provide great flexibility in that they can be adapted to many different desired purposes by the use of suitable software. As well as being used in the familiar general purpose computers, software-controlled processors are now used in many products such as cars, telephones and other domestic products, where they are known as embedded systems.

However, for a given a function, a software-controlled processor is usually slower than hardware dedicated to that function. A way of overcoming this problem is to use a special software-controlled processor such as a RISC processor which can be made to function more quickly for limited purposes by having its parameters (for instance size, instruction set etc.) tailored to the desired functionality.

Where hardware is used, though, although it increases the speed of operation, it lacks flexibility and, for instance, although it may be suitable for the task for which it was designed it may not be suitable for a modified version of that task which is desired later. It is now possible to form the hardware on reconfigurable logic circuits, such as Field Programmable Gate Arrays (FPGA's) which are logic circuits which can be repeatedly reconfigured in different ways. Thus they provide the speed advantages of dedicated hardware, with some degree of flexibility for later updating or multiple functionality.

Varoius computer boards, such as the MMT2000® board, are designed in such a way that two FPGAs are connected to each physical device on the board. Thus each is individually able to drive all of the devices on the board. However, two main problems arise when trying to access a resource from both FPGAs.

In particular, the first problem is related to external memory and arises because Handel-C, a programming language for programming FPGAs, is not able to tristate the control and address lines to external RAMs. Thus, each RAM bank (and the FLASH memory which shares address pins with one of the RAM banks) can only be accessed from one FPGA.

The second problem arises when trying to transfer control of a device from one FPGA to the other, both because most existing device drivers are not designed to exit cleanly and because even if they did, most devices would require resetting and reinitialising every time control was transferred (an unnecessarily time-consuming procedure).

### SUMMARY OF THE INVENTION

A system, method and computer program product for arbitrating access to a shared memory resource by a plurality of gate arrays. During use, operations are executed on a plurality of gate arrays. Further, the gate arrays are allowed access to at least one shared memory resource during the execution of the operations thereon. Such access to the at least one shared memory resource is arbritrated to prevent conflict between the gate arrays.

In one embodiment of the present invention, the arbitration step avoids reinitialization of the device drivers on the gate arrays. To accomplish this, the arbitration step may include locking the at least one shared memory resource while communications are in progress with the gate arrays, preventing server data from being interleaved with other data, preventing a sound driver from locking access to the at least one shared memory, and/or controlling a graphical user interface.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2 is a schematic diagram of one embodiment of the present invention where the central processing unit interfaces with a pair of gate arrays via a parallel port;

FIG. 3 illustrates a method for arbitrating access to a shared memory resource by a plurality of gate arrays; and

FIGS. 4 and 5 illustrate various external dependencies and Handel-C Macros, respectively, in accordance with one embodiment of the present invention.

### DETAILED DESCRIPTION OF THE PREFERRED EMBODIMENTS

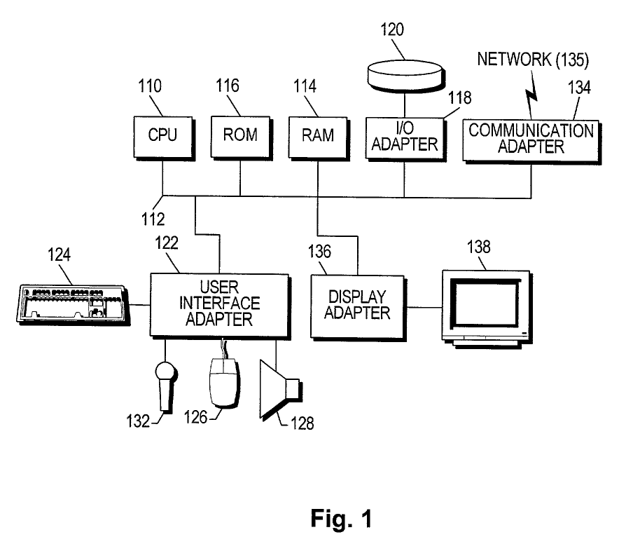

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

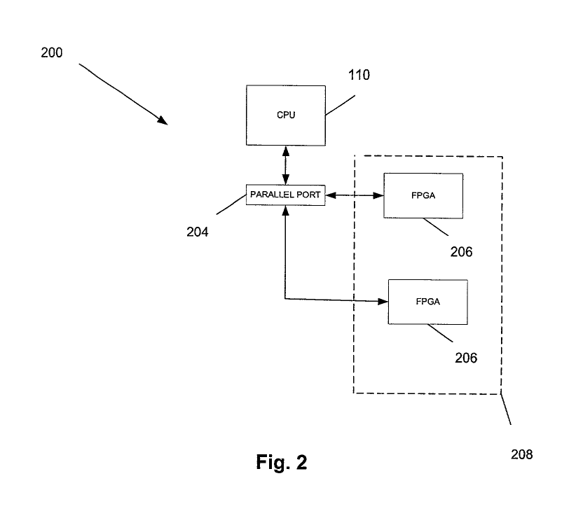

FIG. 2 is a schematic diagram of one embodiment 200 of the present invention where the central processing unit 110 interfaces with a pair of gate arrays 206 via a parallel port 204. In one embodiment, the gate arrays are positioned on a MMT2000® dual Vertex board.

Examples of such FPGA devices include the XC2000® and XC3000™ families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGA's of any type may be employed in the context of the present invention.

An FPGA device can be characterized as an integrated circuit that has four major features as follows.

(1) A user-accessible, configuration-defining memory means, such as SRAM, PROM, EPROM, EEPROM, anti-fused, fused, or other, is provided in the FPGA device so as to be at least once-programmable by device users for defining user-provided configuration instructions. Static Random Access Memory or SRAM is of course, a form of reprogrammable memory that can be differently programmed many times. Electrically Erasable and reProgrammable ROM or EEPROM is an example of nonvolatile reprogrammable memory. The configuration-defining memory of an FPGA device can be formed of mixture of different kinds of memory elements if desired (e.g., SRAM and EEPROM) although this is not a popular approach.

(2) Input/Output Blocks (IOB's) are provided for interconnecting other internal circuit components of the FPGA device with external circuitry. The IOB's' may have fixed configurations or they may be configurable in accordance with user-provided configuration instructions stored in the configuration-defining memory means.

(3) Configurable Logic Blocks (CLB's) are provided for carrying out user-programmed logic functions as defined by user-provided configuration instructions stored in the configuration-defining memory means.

Typically, each of the many CLB's of an FPGA has at least one lookup table (LUT) that is user-configurable to define any desired truth table,—to the extent allowed by the address space of the LUT. Each CLB may have other resources such as LUT input signal pre-processing resources and LUT output signal post-processing resources. Although the term ‘CLB’ was adopted by early pioneers of FPGA technology, it is not uncommon to see other names being given to the repeated portion of the FPGA that carries out user-programmed logic functions. The term, ‘LAB’ is used for example in U.S. Pat. No. 5,260,611 to refer to a repeated unit having a 4-input LUT.

(4) An interconnect network is provided for carrying signal traffic within the FPGA device between various CLB's and/or between various IOB's and/or between various IOB's and CLB's. At least part of the interconnect network is typically configurable so as to allow for programmably-defined routing of signals between various CLB's and/or IOB's in accordance with user-defined routing instructions stored in the configuration-defining memory means.

In some instances, FPGA devices may additionally include embedded volatile memory for serving as scratchpad memory for the CLB's or as FIFO or LIFO circuitry. The embedded volatile memory may be fairly sizable and can have 1 million or more storage bits in addition to the storage bits of the device's configuration memory.

Modern FPGA's tend to be fairly complex. They typically offer a large spectrum of user-configurable options with respect to how each of many CLB's should be configured, how each of many interconnect resources should be configured, and/or how each of many IOB's should be configured. This means that there can be thousands or millions of configurable bits that may need to be individually set or cleared during configuration of each FPGA device.

Rather than determining with pencil and paper how each of the configurable resources of an FPGA device should be programmed, it is common practice to employ a computer and appropriate FPGA-configuring software to automatically generate the configuration instruction signals that will be supplied to, and that will ultimately cause an unprogrammed FPGA to implement a specific design. (The configuration instruction signals may also define an initial state for the implemented design, that is, initial set and reset states for embedded flip flops and/or embedded scratchpad memory cells.)

The number of logic bits that are used for defining the configuration instructions of a given FPGA device tends to be fairly large (e.g., 1 Megabits or more) and usually grows with the size and complexity of the target FPGA. Time spent in loading configuration instructions and verifying that the instructions have been correctly loaded can become significant, particularly when such loading is carried out in the field.

For many reasons, it is often desirable to have in-system reprogramming capabilities so that reconfiguration of FPGA's can be carried out in the field.

FPGA devices that have configuration memories of the reprogrammable kind are, at least in theory, ‘in-system programmable’ (ISP). This means no more than that a possibility exists for changing the configuration instructions within the FPGA device while the FPGA device is ‘in-system’ because the configuration memory is inherently reprogrammable. The term, ‘in-system’ as used herein indicates that the FPGA device remains connected to an application-specific printed circuit board or to another form of end-use system during reprogramming. The end-use system is of course, one which contains the FPGA device and for which the FPGA device is to be at least once configured to operate within in accordance with predefined, end-use or ‘in the field’ application specifications.

The possibility of reconfiguring such inherently reprogrammable FPGA's does not mean that configuration changes can always be made with any end-use system. Nor does it mean that, where in-system reprogramming is possible, that reconfiguration of the FPGA can be made in timely fashion or convenient fashion from the perspective of the end-use system or its users. (Users of the end-use system can be located either locally or remotely relative to the end-use system.)

Although there may be many instances in which it is desirable to alter a pre-existing configuration of an ‘in the field’ FPGA (with the alteration commands coming either from a remote site or from the local site of the FPGA), there are certain practical considerations that may make such in-system reprogrammability of FPGA's more difficult than first apparent (that is, when conventional techniques for FPGA reconfiguration are followed).

A popular class of FPGA integrated circuits (IC's) relies on volatile memory technologies such as SRAM (static random access memory) for implementing on-chip configuration memory cells. The popularity of such volatile memory technologies is owed primarily to the inherent reprogrammability of the memory over a device lifetime that can include an essentially unlimited number of reprogramming cycles.

There is a price to be paid for these advantageous features, however. The price is the inherent volatility of the configuration data as stored in the FPGA device. Each time power to the FPGA device is shut off, the volatile configuration memory cells lose their configuration data. Other events may also cause corruption or loss of data from volatile memory cells within the FPGA device.

Some form of configuration restoration means is needed to restore the lost data when power is shut off and then re-applied to the FPGA or when another like event calls for configuration restoration (e.g., corruption of state data within scratchpad memory).

The configuration restoration means can take many forms. If the FPGA device resides in a relatively large system that has a magnetic or optical or opto-magnetic form of nonvolatile memory (e.g., a hard magnetic disk)—and the latency of powering up such a optical/magnetic device and/or of loading configuration instructions from such an optical/magnetic form of nonvolatile memory can be tolerated—then the optical/magnetic memory device can be used as a nonvolatile configuration restoration means that redundantly stores the configuration data and is used to reload the same into the system's FPGA device(s) during power-up operations (and/or other restoration cycles).

On the other hand, if the FPGA device(s) resides in a relatively small system that does not have such optical/magnetic devices, and/or if the latency of loading configuration memory data from such an optical/magnetic device is not tolerable, then a smaller and/or faster configuration restoration means may be called for.

Many end-use systems such as cable-TV set tops, satellite receiver boxes, and communications switching boxes are constrained by prespecified design limitations on physical size and/or power-up timing and/or security provisions and/or other provisions such that they cannot rely on magnetic or optical technologies (or on network/satellite downloads) for performing configuration restoration. Their designs instead call for a relatively small and fast acting, non-volatile memory device (such as a securely-packaged EPROM IC), for performing the configuration restoration function. The small/fast device is expected to satisfy application-specific criteria such as: (1) being securely retained within the end-use system; (2) being able to store FPGA configuration data during prolonged power outage periods; and (3) being able to quickly and automatically re-load the configuration instructions back into the volatile configuration memory (SRAM) of the FPGA device each time power is turned back on or another event calls for configuration restoration.

The term ‘CROP device’ will be used herein to refer in a general way to this form of compact, nonvolatile, and fast-acting device that performs ‘Configuration-Restoring On Power-up’ services for an associated FPGA device.

Unlike its supported, volatilely reprogrammable FPGA device, the corresponding CROP device is not volatile, and it is generally not ‘in-system programmable’. Instead, the CROP device is generally of a completely nonprogrammable type such as exemplified by mask-programmed ROM IC's or by once-only programmable, fuse-based PROM IC's. Examples of such CROP devices include a product family that the Xilinx company provides under the designation ‘Serial Configuration PROMs’ and under the trade name, XC1700D.TM. These serial CROP devices employ one-time programmable PROM (Programmable Read Only Memory) cells for storing configuration instructions in nonvolatile fashion.

A preferred embodiment is written using Handel-C. Handel-C is a programming language marketed by Celoxica Limited. Handel-C is a programming language that enables a software or hardware engineer to target directly FPGAs (Field Programmable Gate Arrays) in a similar fashion to classical microprocessor cross-compiler development tools, without recourse to a Hardware Description Language. Thereby allowing the designer to directly realize the raw real-time computing capability of the FPGA.

Handel-C is designed to enable the compilation of programs into synchronous hardware; it is aimed at compiling high level algorithms directly into gate level hardware.

The Handel-C syntax is based on that of conventional C so programmers familiar with conventional C will recognize almost all the constructs in the Handel-C language.

Sequential programs can be written in Handel-C just as in conventional C but to gain the most benefit in performance from the target hardware its inherent parallelism must be exploited.

Handel-C includes parallel constructs that provide the means for the programmer to exploit this benefit in his applications. The compiler compiles and optimizes Handel-C source code into a file suitable for simulation or a net list which can be placed and routed on a real FPGA.

More information regarding the Handel-C programming language may be found in “EMBEDDED SOLUTIONS Handel-C Language Reference Manual: Version 3,” “EMBEDDED SOLUTIONS Handel-C User Manual: Version 3.0,” “EMBEDDED SOLUTIONS Handel-C Interfacing to other language code blocks: Version 3.0,” each authored by Rachel Ganz, and published by Celoxica Limited in the year of 2001; and “EMBEDDED SOLUTIONS Handel-C Preprocessor Reference Manual: Version 2.1,” also authored by Rachel Ganz and published by Embedded Solutions Limited in the year of 2000; and which are each incorporated herein by reference in their entirety. Additional information may also be found in a co-pending application entitled “SYSTEM, METHOD AND ARTICLE OF MANUFACTURE FOR INTERFACE CONSTRUCTS IN A PROGRAMMING LANGUAGE CAPABLE OF PROGRAMMING HARDWARE ARCHITECTURES” which was filed Jan. 29, 2001 under Ser. No. 09/772,555, and which is incorporated herein by reference in its entirety.

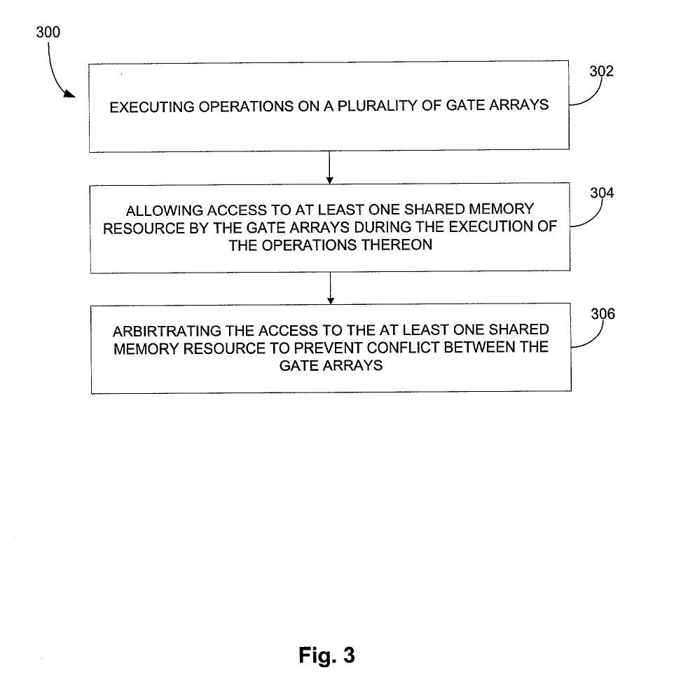

FIG. 3 illustrates a method 300 for arbitrating access to a shared memory resource by a plurality of gate arrays. During use, operations are executed on a plurality of gate arrays, as indicated in step 302. In one embodiment, the gate arrays included FPGA's.

Further, in operation 304, the gate arrays are allowed access to at least one shared memory resource during the execution of the operations thereon. Such access to the at least one shared memory resource is arbritrated to prevent conflict between the gate arrays. See operation 306.

The present invention allows access to external memory and FLASH from both gate arrays whilst using the RAM construct. Further, it provides arbitration thus preventing conflicts when both FPGAs are accessing the same resource. Also, the present invention removes the need to stop and reinitialize drivers and hardware when passing from one FPGA to the other.

One of the key features of the MMT2000® board includes the ability to reconfigure itself both from Flash and over the Ethernet. It is apparent that there is a natural division of the roles of the two FPGAs. One (the server, or FP0) has access to the Flash and the Network and includes the reconfiguration device driver. The other (the client application or FP1) has control over the display, touchscreen and the audio chip.

The present invention encapsulates a bi-directional 16 bit communications driver for allowing the two FPGAs to talk to each other. Every message from one FPGA to the other is preceded by a 16 bit ID, the high eight bits of which identify the type of message (AUDIO, FLASH, RECONFIGURATION etc . . . ) and the low identify the particular request for that hardware (FLASH_READ etc . . . ). The identifier codes are processed in a header file (e.g. “fp0server.h” in the context of the Handel-C programming language), and then an appropriate macro procedure is called for each type of message (e.g. for AUDIO→AudioRequest) which then receives and processes the main body of the communication.

The server process requires a number of parameters to be passed to it. Such parameters will now be set forth.

PID: Used for locking shared resources (such as the FLASH) from other processes while communications are in progress.

usendCommand, uSendLock: A channel allowing applications on FP0 to send commands to applications on FP1 and a one-bit locking variable to ensure the data is not interleaved with server-sent data.

uSoundOut, uSoundIn: Two channels mirroring the function of the audio driver. Data sent to uSoundOut will be played (assuming the correct code in FP1) out of the MMT2000® speakers, and data read from uSoundIn is the input to the MMT2000® microphone. The channels are implemented in such a way that when the sound driver blocks, the communication channel between FPGAs is not held up.

MP3Run: A one bit variable controlling the MP3 GUI. The server will activate or deactivate the MP3 GUI on receipt of commands from FP1.

ConfigAddr: A 23 bit channel controlling the reconfiguration process. When the flash address of a valid FPGA bitfile is sent to this channel, the server reconfigures FP1 with the bitmap specified.

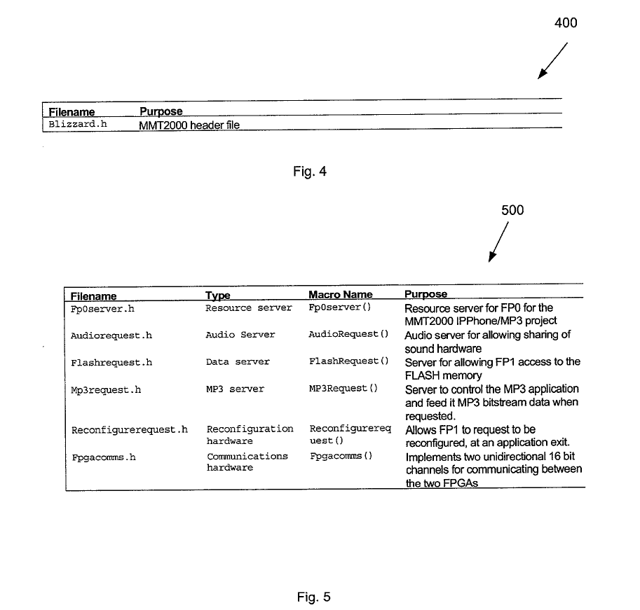

During use, the data transfer rate between the two FPGAs in either direction is 16 bits per 5 clock cycles (in the clock domain of the slowest FPGA). This is the maximum possible reliable rate for communicating between FPGAs that may be running at different clock rates. FIGS. 4 and 5 illustrate various external dependencies 400 and Handel-C Macros 500, respectively, in accordance with one embodiment of the present invention. Note Appendix A.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for arbitrating access to a shared memory resource by a plurality of gate arrays, comprising the steps of:
(a) executing operations on a plurality of gate arrays;
(b) allowing access to at least one shared memory resource by the gate arrays during the execution of the operations thereon; and
(c) arbirtrating the access to the at least one shared memory resource to prevent conflict between the gate arrays.

2. A method as recited in claim 1, wherein arbitration step avoids reinitialization of the device drivers on the gate arrays.

3. A method as recited in claim 1, wherein the arbitration step includes locking the at least one shared memory resource while communications are in progress with the gate arrays.

4. A method as recited in claim 1, wherein the arbitration step includes preventing server data from being interleaved with other data.

5. A method as recited in claim 1, wherein the arbitration step includes preventing a sound driver from locking access to the at least one shared memory resource.

6. A method as recited in claim 1, wherein the arbitration step includes controlling a graphical user interface.

7. A computer program product for arbitrating access to a shared memory resource by a plurality of gate arrays, comprising:
(a) computer code for executing operations on a plurality of gate arrays;
(b) computer code for allowing access to at least one shared memory resource by the gate arrays during the execution of the operations thereon; and
(c) computer code for arbirtrating the access to the at least one shared memory resource to prevent conflict between the gate arrays.

8. A computer program product as recited in claim 7, wherein arbitration step avoids reinitialization of the device drivers on the gate arrays.

9. A computer program product as recited in claim 7, wherein the arbitration step includes locking the at least one shared memory resource while communications are in progress with the gate arrays.

10. A computer program product as recited in claim 7, wherein the arbitration step includes preventing server data from being interleaved with other data.

11. A computer program product as recited in claim 7, wherein the arbitration step includes preventing a sound driver from locking access to the at least one shared memory resource.

12. A computer program product as recited in claim 7, wherein the arbitration step includes controlling a graphical user interface.

13. A system for arbitrating access to a shared memory resource by a plurality of gate arrays, comprising:
(a) logic for executing operations on a plurality of gate arrays;
(b) logic for allowing access to at least one shared memory resource by the gate arrays during the execution of the operations thereon; and
(c) logic for arbirtrating the access to the at least one shared memory resource to prevent conflict between the gate arrays.

14. A system as recited in claim 13, wherein arbitration step avoids reinitialization of the device drivers on the gate arrays.

15. A system as recited in claim 13, wherein the arbitration step includes locking the at least one shared memory resource while communications are in progress with the gate arrays.

16. A system as recited in claim 13, wherein the arbitration step includes preventing server data from being interleaved with other data.

17. A system as recited in claim 13, wherein the arbitration step includes preventing a sound driver from locking access to the at least one shared memory resource.

18. A system as recited in claim 13, wherein the arbitration step includes controlling a graphical user interface.
